(19) United States
(12) Patent Application Publication
(10) Pub. No.: US 2026/0156342 A1
(43) Pub. Date: Jun. 4, 2026

(54) CAMERA MODULE

(71) Applicant: Japan Display Inc., Tokyo (JP)

(72) Inventors: Koichi IGETA, Tokyo (JP); Yoshiro AOKI, Tokyo (JP); Kasumi HASE, Tokyo (JP)

(73) Assignee: Japan Display Inc., Tokyo (JP)

(21) Appl. No.: 19/401,396

(22) Filed: Nov. 26, 2025

(30) Foreign Application Priority Data
Dec. 3, 2024 (JP) 2024-210574

(51) Int. Cl. H04N 23/55; G02F 1/1343; G02F 1/137

(52) U.S. Cl. CPC H04N 23/55; G02F 1/134327; G02F 1/13725

(57) ABSTRACT

A camera module includes a liquid crystal panel that has an incident light control area, a lens, an imaging device that acquires information of light transmitted through the incident light control area and the lens, and a control circuit. The liquid crystal panel includes a first guest-host liquid crystal cell that has a black state and a transparent state, a second guest-host liquid crystal cell that has a black state and a transparent state, and a liquid crystal device that is provided between the first guest-host liquid crystal cell and the second guest-host liquid crystal cell and has the incident light control area. The control circuit sets the first guest-host liquid crystal cell and the second guest-host liquid crystal cell to the black state to use the first guest-host liquid crystal cell and the second guest-host liquid crystal cell as polarizing plates.

### CROSS-REFERENCE TO RELATED APPLICATION

The present application claims priority from Japanese Patent Application JP 2024-210574 filed on Dec. 3, 2024, the contents of which is hereby incorporated by reference into this application.

### BACKGROUND OF THE INVENTION

### (1) Field of the Invention

The present disclosure is applicable to a camera module.

### (2) Description of the Related Art

There have been proposed a camera module and an electronic apparatus in which an incident light control area provided in a liquid crystal panel is used to form a coded aperture pair (CAP) pattern (hereinafter, also simply referred to as a coded pattern) to open and close the diaphragm of the camera and to derive (measure) a distance from the camera to a subject (see JP-2022-051426-A).

### SUMMARY OF THE INVENTION

In the case where a diaphragm function is realized by a liquid crystal panel, a pair of polarizing plates is used because the birefringence and optical rotation of the liquid crystal are used to control transmitted light. However, since the color of the polarizing plates stuck to the outside of a substrate is dark, the contrast ratio becomes high, but the transmittance becomes low. In addition, when the polarizing plates are stuck to the outside of the substrate, the polarizing plates are exposed to the outside air, and thus the member deteriorates in the diaphragm function due to use under direct sunlight or long-time use under high-temperature and high-humidity conditions.

An object of the present disclosure is to provide a technique capable of achieving both a high contrast ratio and a high transmittance in an incident light control area provided in a liquid crystal panel.

Other problems and novel features will become apparent from the description of the specification and the accompanying drawings.

A representative outline of the present invention will be briefly described below.

That is, provided is a camera module having: a liquid crystal panel that has an incident light control area; a lens; an imaging device that acquires information of light transmitted through the incident light control area of the liquid crystal panel and the lens; and a control circuit, in which the liquid crystal panel includes: a first guest-host liquid crystal cell that has a black state and a transparent state; a second guest-host liquid crystal cell that has a black state and a transparent state; and a liquid crystal device that is provided between the first guest-host liquid crystal cell and the second guest-host liquid crystal cell and has the incident light control area, and the control circuit sets the first guest-host liquid crystal cell and the second guest-host liquid crystal cell to the black state to use the first guest-host liquid crystal cell and the second guest-host liquid crystal cell as polarizing plates.

### BRIEF DESCRIPTION OF THE DRAWINGS

FIG. 1 is a cross-sectional view for depicting a camera module according to an embodiment;

FIG. 2 is a top view of a liquid crystal panel of FIG. 1;

FIG. 3 is a schematic cross-sectional view of a liquid crystal panel according to a comparative example;

FIG. 4 is a diagram for explaining a problem in the liquid crystal panel;

FIG. 5 is a diagram for explaining a first state of a first configuration example of the liquid crystal panel according to the embodiment;

FIG. 6 is a diagram for explaining a second state of the first configuration example of the liquid crystal panel according to the embodiment;

FIG. 7 is a diagram for explaining a first state of a second configuration example of the liquid crystal panel according to the embodiment;

FIG. 8 is a diagram for explaining a second state of the second configuration example of the liquid crystal panel according to the embodiment;

FIG. 9 is a diagram for explaining the orientation axes of dichroic dyes;

FIG. 10 is a diagram for explaining a configuration of a plurality of incident light control areas TA of an incident light control area PCA;

FIG. 11 is a schematic view for explaining a plurality of divided areas;

FIG. 12 is a conceptual cross-sectional view of a first incident light control area and each divided area;

FIG. 13 is a diagram for explaining examples of patterns according to the diaphragm function of the incident light control area PCA and examples of a CAP pattern;

FIG. 14 is a diagram for explaining a first state of a third configuration example of the liquid crystal panel according to the embodiment;

FIG. 15 is a diagram for explaining a second state of the third configuration example of the liquid crystal panel according to the embodiment;

FIG. 16 is a diagram for explaining divided segment electrodes of a first transparent electrode in a first guest-host liquid crystal cell;

FIG. 17 is a diagram for explaining divided segment electrodes of a third transparent electrode in a second guest-host liquid crystal cell; and

FIG. 18 is a diagram for depicting another configuration example of the incident light control area PCA.

### DETAILED DESCRIPTION OF THE PREFERRED EMBODIMENT

Hereinafter, each embodiment of the present invention will be described with reference to the drawings.

It should be noted that the disclosure is merely an example, and appropriate changes that a person skilled in the art can easily arrive at while maintaining the gist of the invention are naturally included in the scope of the present invention. In addition, in order to make the description clearer, the drawings schematically depict the width, thickness, shape, and the like of each section in some cases in comparison with the actual mode, but they are merely examples and do not limit the interpretation of the present invention.

### Embodiment

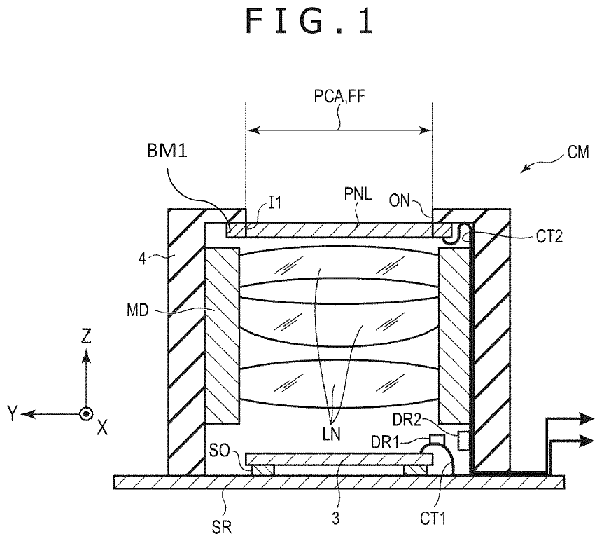

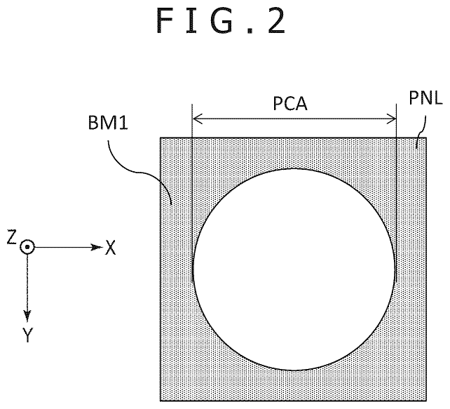

FIG. 1 is a cross-sectional view for depicting a camera module CM according to an embodiment. FIG. 2 is a top view of a liquid crystal panel PNL of FIG. 1. As depicted in FIG. 1, the camera module CM is provided with an imaging device 3, a liquid crystal panel PNL having an incident light control area PCA, and lenses LN positioned between the imaging device 3 and the liquid crystal panel PNL. The camera module CM is provided with, for example, a plurality of lenses LN. A driving body MD of the camera module CM can adjust the relative positional relation or the like of the plurality of lenses LN, and can contribute to, for example, focus adjustment. The driving body MD is housed in a case 4 together with the lenses LN. The case 4 is formed of, for example, resin.

The imaging device 3 is fixed to a substrate SR via a support SO. The substrate SR is a rigid substrate. Accordingly, the substrate SR can excellently fix the relative positional relation or the like between the imaging device 3 and the liquid crystal panel PNL. However, the substrate SR may be a flexible print circuit substrate. The imaging device 3 is also housed in the case 4. The case 4 is fixed to the substrate SR.

The liquid crystal panel PNL is not provided with a display area in this example. In the incident light control area PCA of the liquid crystal panel PNL, an area FF inside an inner circumference I1 of a first light shielding section BM1 is contained inside an opening ON of the case 4. The liquid crystal panel PNL is attached to the case 4 by, for example, fixing means such as double-sided tape. In the present embodiment, the liquid crystal panel PNL is housed in the case 4. As depicted in FIG. 2, the liquid crystal panel PNL has a rectangular shape in this example when viewed from the top. The circular-shaped incident light control area PCA is provided in the liquid crystal panel PNL. The periphery of the incident light control area PCA is surrounded by the first light shielding section BM1. The liquid crystal panel PNL may have a circular shape when viewed from the top.

The imaging device 3 is arranged directly below the incident light control area PCA so that information of light transmitted through the incident light control area PCA (area FF) of the liquid crystal panel PNL and the lenses LN can be acquired.

The camera module CM is further provided with a first circuit substrate CT1 and a second circuit substrate CT2. The first circuit substrate CT1 and the second circuit substrate CT2 are, for example, flexible print circuit substrates. The first circuit substrate CT1 is connected to the imaging device 3. The second circuit substrate CT2 is connected to the liquid crystal panel PNL. In the present embodiment, the first circuit substrate CT1 and the second circuit substrate CT2 are physically independent of each other. However, the first circuit substrate CT1 and the second circuit substrate CT2 may be integrally formed.

The camera module CM is further provided with a first driving circuit DR1 and a second driving circuit DR2. The first driving circuit DR1 is provided on the first circuit substrate CT1 and can drive the imaging device 3. The second driving circuit DR2 is provided on the second circuit substrate CT2 and can drive the liquid crystal panel PNL. The second driving circuit DR2 is also referred to as a control circuit DR2.

In the present embodiment, each of the first circuit substrate CT1 and the second circuit substrate CT2 is electrically connected to wiring of the substrate SR. The first circuit substrate CT1 and the second circuit substrate CT2 are electrically connected to each other via the substrate SR. In this case, the first driving circuit DR1 and the second driving circuit DR2 may be integrally formed and provided on the first circuit substrate CT1 or the second circuit substrate CT2.

The incident light control area PCA is configured to be capable of being used to form a coded aperture pair (CAP) pattern (hereinafter, also simply referred to as a CAP pattern or a coded pattern) to open and close the diaphragm of the camera and to derive (measure) a distance from the camera to a subject under control of the second driving circuit DR2.

According to the camera module CM configured as depicted in FIG. 1, it is possible to obtain the camera module CM that can excellently perform photographing. In addition, since the CAP can be formed in the incident light control area PCA of the liquid crystal panel PNL, information of the distance from the camera module CM to the subject can be acquired by the camera module CM alone.

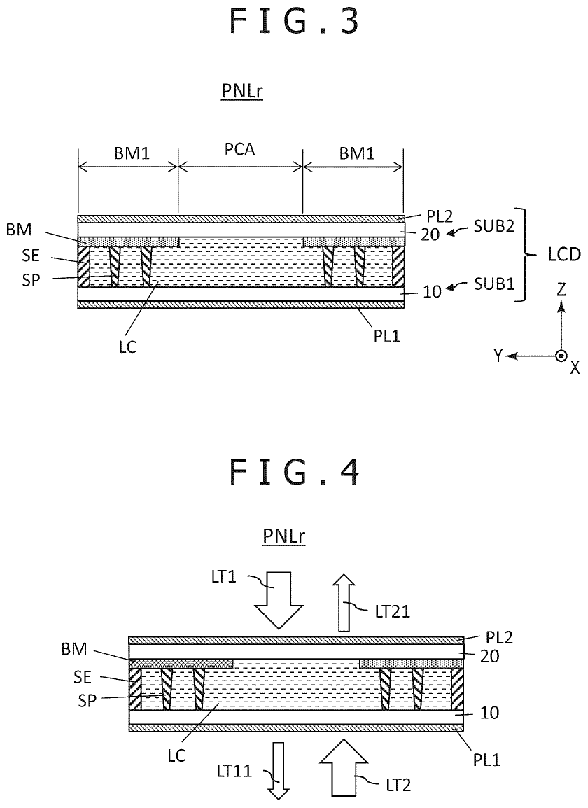

FIG. 3 is a schematic cross-sectional view of a liquid crystal panel according to a comparative example. FIG. 4 is a diagram for explaining a problem in the liquid crystal panel.

As depicted in FIG. 2, the liquid crystal panel PNL is provided with the first light shielding section BM1 configured with a light shielding film BM, and the incident light control area PCA surrounded by the light shielding film BM and having a circular shape. The incident light control area PCA is positioned at an opening section of the light shielding film BM. As depicted in FIG. 3, a liquid crystal panel PNLr has a liquid crystal device LCD, a first polarizing plate PL1, and a second polarizing plate PL2 provided above the liquid crystal device LCD. The first polarizing plate PL1 is provided under the liquid crystal device LCD and the second polarizing plate PL2 is provided above the liquid crystal device LCD so that the liquid crystal device LCD is provided between the first polarizing plate PL1 and the second polarizing plate PL2.

The liquid crystal device LCD is provided with a first substrate SUB1, a second substrate SUB2, a liquid crystal layer LC, a sealing material SE, and a spacer SP. The sealing material SE and the spacer SP are positioned at the first light shielding section BM1 to join the first substrate SUB1 and the second substrate SUB2 to each other. The first polarizing plate PL1 is provided under the first substrate SUB1. The second polarizing plate PL2 is provided above the second substrate SUB2.

The liquid crystal layer LC is positioned at the first light shielding section BM1 and the incident light control area PCA, and is held between the first substrate SUB1 and the second substrate SUB2. The liquid crystal layer LC is provided in a space surrounded by the first substrate SUB1, the second substrate SUB2, and the sealing material SE.

The first substrate SUB1 is provided with a first insulating substrate 10, a first orientation film (not illustrated), and a first electrode (not illustrated). The second substrate SUB2 is provided with a second insulating substrate 20, a light shielding layer BM, a second orientation film (not illustrated), and a second electrode (not illustrated). The first insulating substrate 10 and the second insulating substrate 20 are transparent substrates such as glass substrates or flexible resin substrates. The first orientation film and the second orientation film are in contact with the liquid crystal layer LC. The light shielding layer BM is positioned between the second insulating substrate 20 and the liquid crystal layer LC. The light shielding layer BM can be rephrased as a light shielding film.

The liquid crystal device LCD may be provided with any of configurations adapted to a display mode using a horizontal electric field along the principal surface of the substrate, a display mode using a vertical electric field along the normal of the principal surface of the substrate, a display mode using an inclined electric field inclined in a direction oblique to the principal surface of the substrate, and a display mode using an appropriate combination of the horizontal electric field, the vertical electric field, and the inclined electric field described above. The principal surface of the substrate in this case is a surface parallel to the X-Y plane.

As depicted in FIG. 4, in the case where a diaphragm function is realized by the incident light control area PCA of the liquid crystal panel PLNr, a pair of polarizing plates PL1 and PL2 is used because the birefringence property and the optical rotation property of the liquid crystal layer LC are used to control transmitted light. However, since the color of the polarizing plates PL1 and PL2 stuck to the outside of the first insulating substrate 10 and the second insulating substrate 20 is dark, the contrast ratio becomes high, but light LT1 is absorbed by the polarizing plates PL1 and PL2 to become light LT11, and light LT2 is absorbed by the polarizing plates PL2 and PL1 to become light LT21, so that the transmittance becomes low.

In addition, when the polarizing plate PL1 is stuck to the outside of the first insulating substrate 10, the polarizing plate PL1 is exposed to the outside air. Therefore, when the polarizing plate PL1 is used under direct sunlight or under high-temperature and high-humidity conditions for a long period of time, it is considered that the member of the polarizing plate PL1 deteriorates in the diaphragm function of the incident light control area PCA.

Thus, in the liquid crystal panel PLN according to the embodiment of the present disclosure, a pair of guest-host liquid crystal cells (GHL1 and GHL2) is employed instead of the polarizing plates PL1 and PL2. The guest-host liquid crystal cells GHL1 and GHL2 are provided outside the first insulating substrate 10 and the second insulating substrate 20, respectively. That is, the liquid crystal device LCD is provided between the first guest-host liquid crystal cell GHL1 and the second guest-host liquid crystal cell GHL2.

The guest-host liquid crystal cells GHL1 and GHL2 are set to a black state (polarizing plate state) when the incident light control area PCA is used for distance measurement by displaying the CAP pattern on the incident light control area PCA, and are set to a transparent state when the incident light control area PCA is not used for distance measurement. The black state and the transparent state of the guest-host liquid crystal cells GHL1 and GHL2 are controlled by, for example, the second driving circuit DR2.

Thus, the following effects can be obtained by the liquid crystal panel PLN according to the embodiment of the present disclosure.

1) When the incident light control area PCA is used for distance measurement by displaying the CAP pattern on the incident light control area PCA, the guest-host liquid crystal cells GHL1 and GHL2 are set to a black state and the guest-host liquid crystal cells GHL1 and GHL2 are allowed to act as polarizing plates. Accordingly, a high contrast ratio is obtained.

2) When the incident light control area PCA is not used for distance measurement, the guest-host liquid crystal cells GHL1 and GHL2 are set to a transparent state, and the guest-host liquid crystal cells GHL1 and GHL2 are not allowed to act as polarizing plates. Accordingly, a high transmittance is obtained.

3) Accordingly, in the liquid crystal panel PNL according to the embodiment, both a high contrast ratio and a high transmittance suitable for an application can be achieved.

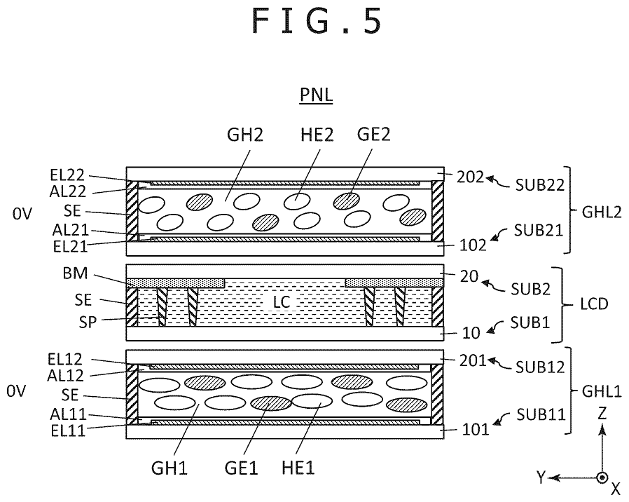

Hereinafter, the liquid crystal panel PLN according to the embodiment will be described by using FIG. 5 to FIG. 8. The configuration of the incident light control area PCA, the CAP pattern displayed on the incident light control area PCA, and the diaphragm function will be described later.

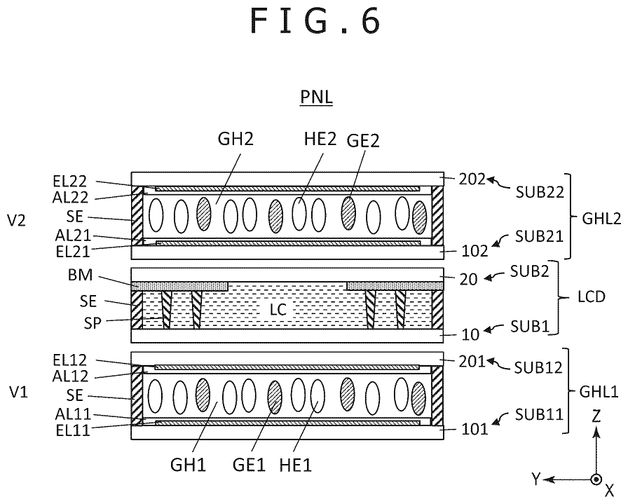

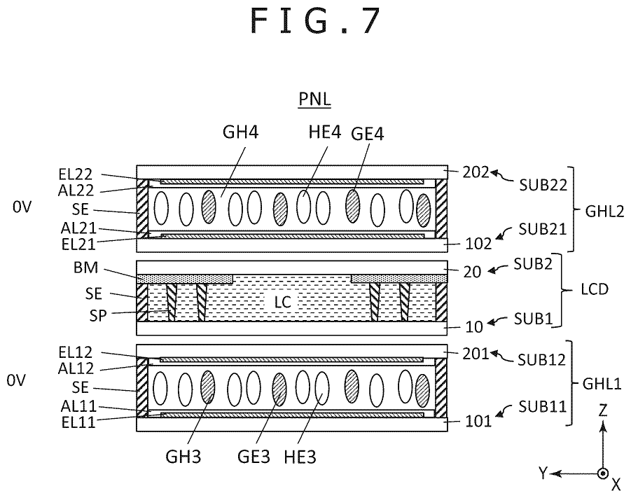

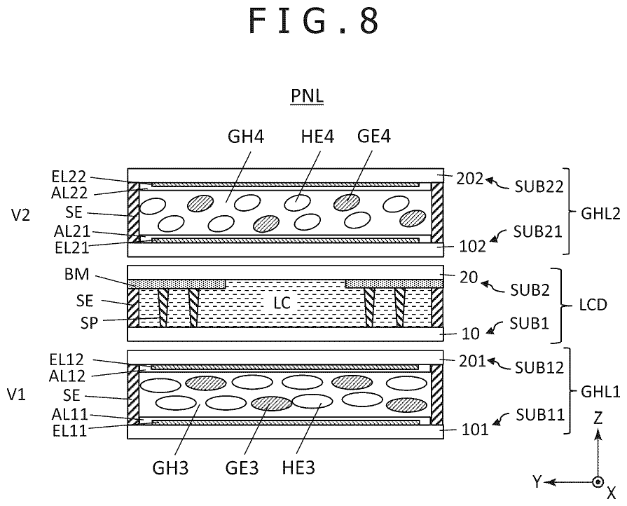

FIG. 5 is a diagram for explaining a first state of a first configuration example of the liquid crystal panel according to the embodiment. FIG. 6 is a diagram for explaining a second state of the first configuration example of the liquid crystal panel according to the embodiment. FIG. 7 is a diagram for explaining a first state of a second configuration example of the liquid crystal panel according to the embodiment. FIG. 8 is a diagram for explaining a second state of the second configuration example of the liquid crystal panel according to the embodiment.

The liquid crystal panel PNL depicted in FIG. 5 and FIG. 6 has the liquid crystal device LCD, the first guest-host liquid crystal cell GHL1, and the second guest-host liquid crystal cell GHL2. The liquid crystal device LCD is provided between the first guest-host liquid crystal cell GHL1 and the second guest-host liquid crystal cell GHL2. The first guest-host liquid crystal cell GHL1 is provided under the first insulating substrate 10 of the liquid crystal device LCD, and the second guest-host liquid crystal cell GHL2 is provided above the second insulating substrate 20 of the liquid crystal device LCD.

Since the configuration of the liquid crystal device LCD is the same as that of the liquid crystal device LCD described with reference to FIG. 3, duplicated description related to the configuration of the liquid crystal device LCD will be omitted.

The first guest-host liquid crystal cell GHL1 is provided with a third substrate SUB11, a fourth substrate SUB12, a second sealing material SE, and a first guest-host liquid crystal layer GH1. The second sealing material SE joins the third substrate SUB11 and the fourth substrate SUB12 to each other.

The first guest-host liquid crystal layer GH1 is held between the third substrate SUB11 and the fourth substrate SUB12. The first guest-host liquid crystal layer GH1 is provided in a space surrounded by the third substrate SUB11, the fourth substrate SUB12, and the second sealing material SE. The first guest-host liquid crystal layer GH1 has a first dichroic dye (guest element) GE1 and a first liquid crystal molecule (host element) HE1. In the first guest-host liquid crystal layer GH1, the orientation axis of the first dichroic dye (guest element) GE1 is, for example, parallel (horizontal orientation) to the Y-axis.

The third substrate SUB11 is provided with a third insulating substrate 101, a first orientation film AL11, and a first transparent electrode EL11. The first transparent electrode EL11 is provided between the third insulating substrate 101 and the first orientation film AL11, and the first orientation film AL11 is in contact with the first guest-host liquid crystal layer GH1.

The fourth substrate SUB12 is provided with a fourth insulating substrate 201, a second orientation film AL12, and a second transparent electrode EL12. The second transparent electrode EL12 is provided between the fourth insulating substrate 201 and the second orientation film AL12, and the second orientation film AL12 is in contact with the first guest-host liquid crystal layer GH1.

The second guest-host liquid crystal cell GHL2 is provided with a fifth substrate SUB21, a sixth substrate SUB22, a third sealing material SE, and a second guest-host liquid crystal layer GH2. The second sealing material SE joins the fifth substrate SUB21 and the sixth substrate SUB22 to each other.

The second guest-host liquid crystal layer GH2 is held between the fifth substrate SUB21 and the sixth substrate SUB22. The second guest-host liquid crystal layer GH2 is provided in a space surrounded by the fifth substrate SUB21, the sixth substrate SUB22, and the third sealing material SE. The second guest-host liquid crystal layer GH2 has a second dichroic dye (guest element) GE2 and a second liquid crystal molecule (host element) HE2. In the second guest-host liquid crystal layer GH2, the orientation axis of the dichroic dye (guest element) GE2 is, for example, parallel (horizontal orientation) to the X-axis.

The fifth substrate SUB21 is provided with a fifth insulating substrate 102, a third orientation film AL21, and a third transparent electrode EL21. The third transparent electrode EL21 is provided between the fifth insulating substrate 102 and the third orientation film AL21, and the third orientation film AL21 is in contact with the second guest-host liquid crystal layer GH2.

The sixth substrate SUB22 is provided with a sixth insulating substrate 202, a fourth orientation film AL22, and a fourth transparent electrode EL22. The fourth transparent electrode EL22 is provided between the sixth insulating substrate 202 and the fourth orientation film AL22, and the fourth orientation film AL22 is in contact with the second guest-host liquid crystal layer GH2.

Here, FIG. 5 depicts a state (0 V) in which no potential is applied between the first transparent electrode EL11 and the second transparent electrode EL12 and between the third transparent electrode EL21 and the fourth transparent electrode EL22 under the control of the second driving circuit DR2. In this case, the first guest-host liquid crystal layer GH1 and the second guest-host liquid crystal layer GH2 are colored in, for example, a black state, and the first guest-host liquid crystal cell GHL1 and the second guest-host liquid crystal cell GHL2 are set to a state in which they can be used as polarizing plates. In this state, the incident light control area PCA can be used for distance measurement by displaying the CAP pattern on the incident light control area PCA. In addition, the incident light control area PCA can be used as a function of opening and closing the diaphragm.

On the other hand, FIG. 6 depicts a state in which predetermined potentials (V1 and V2) are applied between the first transparent electrode EL11 and the second transparent electrode EL12 and between the third transparent electrode EL21 and the fourth transparent electrode EL22 under the control of the second driving circuit DR2. In this case, the first guest-host liquid crystal layer GH1 and the second guest-host liquid crystal layer GH2 are set to a nearly transparent state, and a high transmittance is obtained. In this state, the first guest-host liquid crystal cell GHL1 and the second guest-host liquid crystal cell GHL2 cannot be used as polarizing plates. In addition, the incident light control area PCA is not used for distance measurement in this state.

Liquid crystal panels PNL depicted in FIG. 7 and FIG. 8 are different from the liquid crystal panels PNL depicted in FIG. 5 and FIG. 6 in that a third guest-host liquid crystal layer GH3 and a fourth guest-host liquid crystal layer GH4 used in the liquid crystal panels PNL depicted in FIG. 7 and FIG. 8 are opposite in positive and negative dielectric anisotropies to the first guest-host liquid crystal layer GH1 and the second guest-host liquid crystal layer GH2. The third guest-host liquid crystal layer GH3 has a third dichroic dye (guest element) GE3 and a third liquid crystal molecule (host element) HE3. The fourth guest-host liquid crystal layer GH4 has a fourth dichroic dye (guest element) GE4 and a fourth liquid crystal molecule (host element) HE4.

That is, FIG. 7 depicts a state (0 V) in which no potential is applied between the first transparent electrode EL11 and the second transparent electrode EL12 and between the third transparent electrode EL21 and the fourth transparent electrode EL22 under the control of the second driving circuit DR2, and at this time, the third guest-host liquid crystal layer GH3 and the fourth guest-host liquid crystal layer GH4 are set to a nearly transparent state, and a high transmittance is obtained. That is, the first guest-host liquid crystal cell GHL1 and the second guest-host liquid crystal cell GHL2 are set to a state in which they cannot be used as polarizing plates.

On the other hand, FIG. 8 depicts a state in which predetermined potentials (V1 and V2) are applied between the first transparent electrode EL11 and the second transparent electrode EL12 and between the third transparent electrode EL21 and the fourth transparent electrode EL22 under the control of the second driving circuit DR2. At this time, the third guest-host liquid crystal layer GH3 and the fourth guest-host liquid crystal layer GH4 are colored in, for example, a black state. That is, the first guest-host liquid crystal cell GHL1 and the second guest-host liquid crystal cell GHL2 are set to a state in which they can be used as polarizing plates. In FIG. 8, the orientation axis of the third dichroic dye (guest element) GE3 is, for example, parallel (horizontal orientation) to the Y-axis, and the orientation axis of the dichroic dye (guest element) GE4 is, for example, parallel (horizontal orientation) to the X-axis.

Since other configurations of the liquid crystal panels PNL depicted in FIG. 7 and FIG. 8 are the same as other configurations of the liquid crystal panels PNL depicted in FIG. 5 and FIG. 6, duplicated description will be omitted.

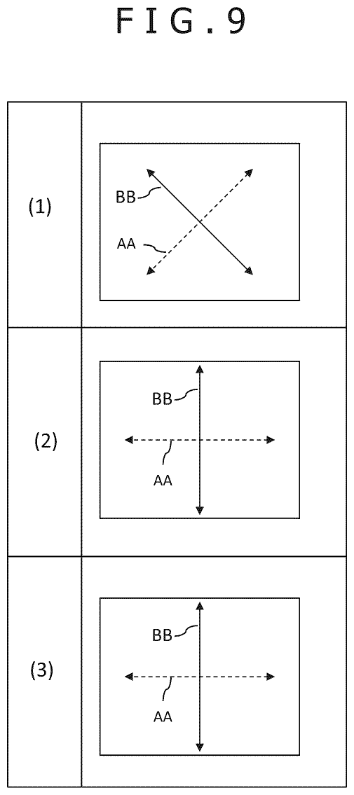

Next, the orientation axes of the dichroic dyes (GE1 to GE4) in a black state will be described by using FIG. 9. FIG. 9 is a diagram for explaining the orientation axes of the dichroic dyes. The orientation axes (also referred to as the major axis directions) of the dichroic dyes (GE1 to GE4) are configured to be in the same directions as the absorption axes of the polarizing plates PL1 and PL2 when the polarizing plates PL1 and PL2 described with reference to FIG. 3 are used. FIG. 9 depicts the orientation axes of the dichroic dyes (GE1 to GE4) according to the panel system of the liquid crystal device LCD. It is assumed in FIG. 9 that dotted arrows AA indicate the orientation axes of the dichroic dyes GE2 and GE4, and solid arrows BB indicate the orientation axes of the dichroic dyes GE1 and GE3.

(1) depicts the orientation axes of the dichroic dyes in the case where the panel system is a twisted nematic system (TN liquid crystal: for example, 90° twisted liquid crystal). In this case, the orientation axes of the dichroic dyes GE2 and GE4 are, for example, 45° as indicated by AA, and those of the dichroic dyes GE1 and GE3 are, for example, 135° as indicated by BB. The orientation axes (major axis directions) of the liquid crystal molecules (HE1, HE2, HE3, and HE4) are also in the same directions as the dichroic dyes (GE1, GE2, GE3, and GE4).

(2) depicts the orientation axes of the dichroic dyes in the case where the panel system is an in-plane-switching (IPS) system or an advanced fringe field switching (FFS) system. In this case, the orientation axes of the dichroic dyes GE2 and GE4 are, for example, parallel (horizontal orientation) to the Y-axis as indicated by AA, and those of the dichroic dyes GE1 and GE3 are, for example, parallel (horizontal orientation) to the X-axis as indicated by BB. The orientation axes (major axis directions) of the liquid crystal molecules (HE1, HE2, HE3, and HE4) are also in the same directions as the dichroic dyes (GE1, GE2, GE3, and GE4).

(3) depicts the orientation axes of the dichroic dyes in the case where the panel system is a vertical alignment (VA) system. In this case, the orientation axes of the dichroic dyes GE2 and GE4 are, for example, parallel (horizontal orientation) to the Y-axis as indicated by AA, and those of the dichroic dyes GE1 and GE3 are, for example, parallel (horizontal orientation) to the X-axis as indicated by BB. The orientation axes of the dichroic dyes GE2 and GE4 may be, for example, 45° as similar to the TN system, and those of the dichroic dyes GE1 and GE3 may be, for example, 135° as similar to the TN system. The orientation axes of the liquid crystal molecules (HE1, HE2, HE3, and HE4) are also in the same directions as the dichroic dyes (GE1, GE2, GE3, and GE4).

Next, the configuration of the incident light control area PCA, the CAP pattern displayed on the incident light control area PCA, and the diaphragm function will be described.

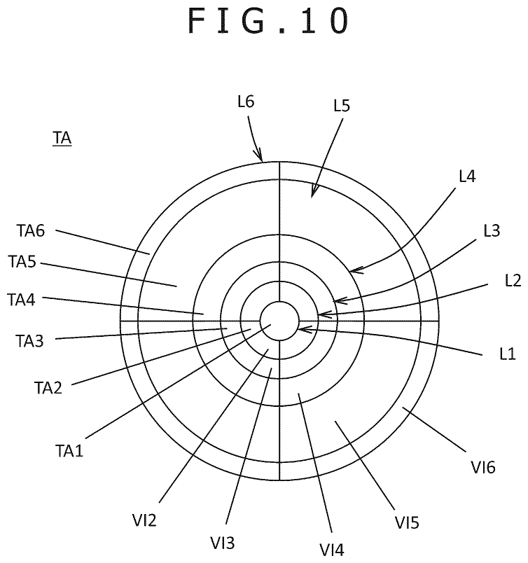

FIG. 10 is a diagram for explaining the configuration of a plurality of incident light control areas TA of the incident light control area PCA. As depicted in FIG. 10, the incident light control area PCA has a first incident light control area TA1 to a sixth incident light control area TA6. Each of the first incident light control area TA1 to the sixth incident light control area TA6 has a wiring pair connected to the control circuit DR2 so that a transmission state for allowing external light (visible light) to transmit and a non-transmission state for blocking external light (visible light) can be set under the control of the control circuit DR2.

The first incident light control area TA1 is arranged at the center position (CP) of the incident light control area PCA and is a circular-shaped area having a diameter L1.

The second incident light control area TA2 is arranged so as to surround the outer periphery of the first incident light control area TA1, and is an annular-shaped area in which the inner periphery of the second incident light control area TA2 has the diameter L1 and the outer periphery of the second incident light control area TA2 has a diameter L2.

The third incident light control area TA3 is arranged so as to surround the outer periphery of the second incident light control area TA2, and is an annular-shaped area in which the inner periphery of the third incident light control area TA3 has the diameter L2 and the outer periphery of the third incident light control area TA3 has a diameter L3.

The fourth incident light control area TA4 is arranged so as to surround the outer periphery of the third incident light control area TA3, and is an annular-shaped area in which the inner periphery of the fourth incident light control area TA4 has the diameter L3 and the outer periphery of the fourth incident light control area TA4 has a diameter L4.

The fifth incident light control area TA5 is arranged so as to surround the outer periphery of the fourth incident light control area TA4, and is an annular-shaped area in which the inner periphery of the fifth incident light control area TA5 has the diameter L4 and the outer periphery of the fifth incident light control area TA5 has a diameter L5.

The sixth incident light control area TA6 is arranged so as to surround the outer periphery of the fifth incident light control area TA5, and is an annular-shaped area in which the inner periphery of the sixth incident light control area TA6 has the diameter L5 and the outer periphery of the sixth incident light control area TA6 has a diameter L6.

Each of the second incident light control area TA2 to the sixth incident light control area TA6 includes a plurality of divided areas divided into multiple in the circumferential direction. The second incident light control area TA2 includes a plurality of second divided areas VI2, the third incident light control area TA3 includes a plurality of third divided areas VI3, and the fourth incident light control area TA4 includes a plurality of fourth divided areas VI4. The fifth incident light control area TA5 includes a plurality of fifth divided areas VI5, and the sixth incident light control area TA6 includes a plurality of sixth divided areas VI6. In this example, the number of divisions of each of the second incident light control area TA2 to the sixth incident light control area TA6 is four and is the equal number. In this example, each of the second incident light control area TA2 to the sixth incident light control area TA6 is divided into four equal parts. The boundaries of the second divided areas VI2, the boundaries of the third divided areas VI3, the boundaries of the fourth divided areas VI4, the boundaries of the fifth divided areas VI5, and the boundaries of the sixth divided areas VI6 are aligned in the radial direction of the incident light control area PCA.

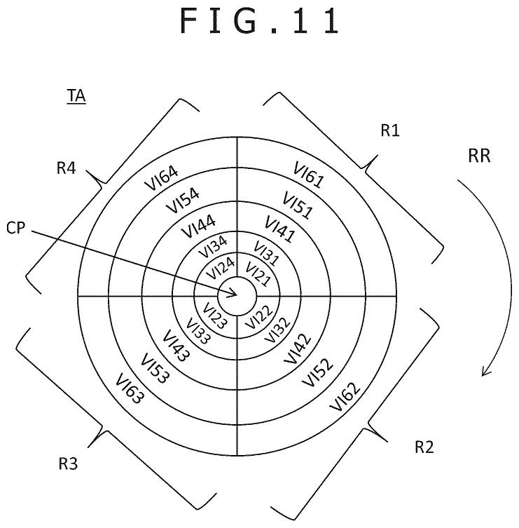

FIG. 11 is a schematic view for explaining the plurality of divided areas. It should be noted that the first incident light control area TA1 to the sixth incident light control area TA6 and the plurality of divided areas (VI2 to VI6) depicted in FIG. 10 are the same in FIG. 11, but the description of the first incident light control area TA1 to the sixth incident light control area TA6 and the plurality of divided areas (VI2 to VI6) depicted in FIG. 10 is omitted in FIG. 11 to avoid complexity of the drawing.

As depicted in FIG. 11, each of the divided areas (VI2 to VI6) is configured to have a first area R1, a second area R2, a third area R3, and a fourth area R4 in the right rotation direction (clockwise) RR with respect to the center position CP of the first incident light control area TA1. Therefore, each of the divided areas is configured as follows.

The second divided areas VI2 of the second incident light control area TA2 are configured with a first area VI21 of the second divided areas, a second area VI22 of the second divided areas, a third area VI23 of the second divided areas, and a fourth area VI24 of the second divided areas.

The third divided areas VI3 of the third incident light control area TA3 are configured with a first area VI31 of the third divided areas, a second area VI32 of the third divided areas, a third area VI33 of the third divided areas, and a fourth area VI34 of the third divided areas.

The fourth divided areas VI4 of the fourth incident light control area TA4 are configured with a first area VI41 of the fourth divided areas, a second area VI42 of the fourth divided areas, a third area VI43 of the fourth divided areas, and a fourth area VI44 of the fourth divided areas.

The fifth divided areas VI5 of the fifth incident light control area TA5 are configured with a first area VI51 of the fifth divided areas, a second area VI52 of the fifth divided areas, a third area VI53 of the fifth divided areas, and a fourth area VI54 of the fifth divided areas.

The sixth divided areas VI6 of the sixth incident light control area TA6 are configured with a first area VI61 of the sixth divided areas, a second area VI62 of the sixth divided areas, a third area VI63 of the sixth divided areas, and a fourth area VI64 of the sixth divided areas.

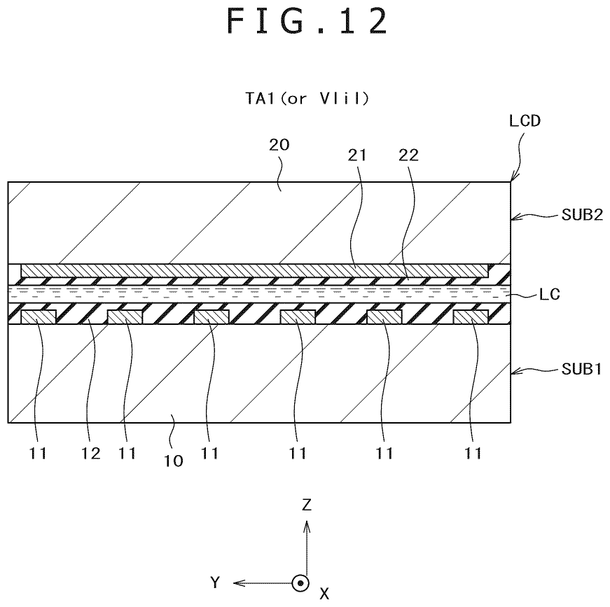

FIG. 12 is a conceptual cross-sectional view of the first incident light control area and each divided area. FIG. 12 depicts a conceptual cross-sectional view for explaining the cross-sectional structure of the first incident light control area TA1 and each area (VIil: i (positive integer)=2 to 6, l (positive integer)=1 to 4) of the respective divided areas (VI2 to VI6).

As depicted in FIG. 12, the liquid crystal device LCD of the liquid crystal panel PNL is provided with the first substrate SUB1, the second substrate SUB2, and the liquid crystal layer LC. The first substrate SUB1 and the second substrate SUB2 face each other. The liquid crystal layer LC is arranged between the first substrate SUB1 and the second substrate SUB2. Although not illustrated in FIG. 12, the sealing material bonds the first substrate SUB1 and the second substrate SUB2 to each other and seals the liquid crystal layer LC. It should be noted that the liquid crystal device LCD of the liquid crystal panel PNL is not provided with a color filter or a light source because it is sufficient to display the coded aperture pair pattern and it is not necessary to display a visible image.

The first substrate SUB1 is provided with a first insulating substrate 10 that is a transparent substrate, pixel electrodes 11 (first electrodes or first control electrodes), and an orientation film 12 (first orientation film). The second substrate SUB2 is provided with a second insulating substrate 20 that is a transparent substrate, a common electrode 21 (a second electrode or a second control electrode), and an orientation film 22 (second orientation film). The pixel electrodes 11 and the common electrode 21 face each other. The orientation film 12 covers the pixel electrodes 11 and is in contact with the liquid crystal layer LC. The orientation film 22 covers the common electrode 21 and is in contact with the liquid crystal layer LC. The pixel electrodes 11 and the common electrode 21 are formed of, for example, a transparent conductive material such as indium tin oxide (ITO) or indium zinc oxide (IZO). The orientation films 12 and 22 are formed of, for example, polyimide films.

For example, in the case where the liquid crystal layer LC is a liquid crystal layer adapted to a normally open mode (normally white), there are a liquid crystal layer LC in an OFF state and a liquid crystal layer LC in an ON state. The OFF state corresponds to a state (for example, a state in which the potential difference between the pixel electrodes 11 and the common electrode 21 is nearly zero) in which no voltage is applied to the liquid crystal layer LC, and the liquid crystal layer LC is in a transmission state in which external light (visible light) is allowed to transmit. The ON state corresponds to a state (for example, a state in which the potential difference between the pixel electrodes 11 and the common electrode 21 is equal to or larger than a threshold value) in which a voltage is applied to the liquid crystal layer LC, and the liquid crystal layer LC is in a non-transmission state in which external light (visible light) is blocked.

In addition, in the case where the liquid crystal layer LC is a liquid crystal layer adapted to a normally closed mode (normally black), there are a liquid crystal layer LC in an OFF state and a liquid crystal layer LC in an ON state. The OFF state corresponds to a state (for example, a state in which the potential difference between the pixel electrodes 11 and the common electrode 21 is nearly zero) in which no voltage is applied to the liquid crystal layer LC, and the liquid crystal layer LC is in a non-transmission state in which external light (visible light) is blocked. The ON state corresponds to a state (for example, a state in which the potential difference between the pixel electrodes 11 and the common electrode 21 is equal to or larger than a threshold value) in which a voltage is applied to the liquid crystal layer LC, and the liquid crystal layer LC is in a transmission state in which external light (visible light) is allowed to transmit.

Here, the potentials between the pixel electrodes 11 and the common electrode 21 are controlled by the control circuit DR2. Accordingly, each of the first incident light control area TA1 and each area (VIil: i (positive integer)=2 to 6, l (positive integer)=1 to 4) of the respective divided areas (VI2 to VI6) can be set to a transmission state or a non-transmission state. Each of the first incident light control area TA1 and each area (VIil: i (positive integer)=2 to 6, l (positive integer)=1 to 4) of the respective divided areas (VI2 to VI6) has a wiring pair for controlling the potentials between the pixel electrodes 11 and the common electrode 21, and each of a plurality of wiring pairs is connected to the control circuit DR2. The control circuit DR2 can independently control each of the plurality of wiring pairs.

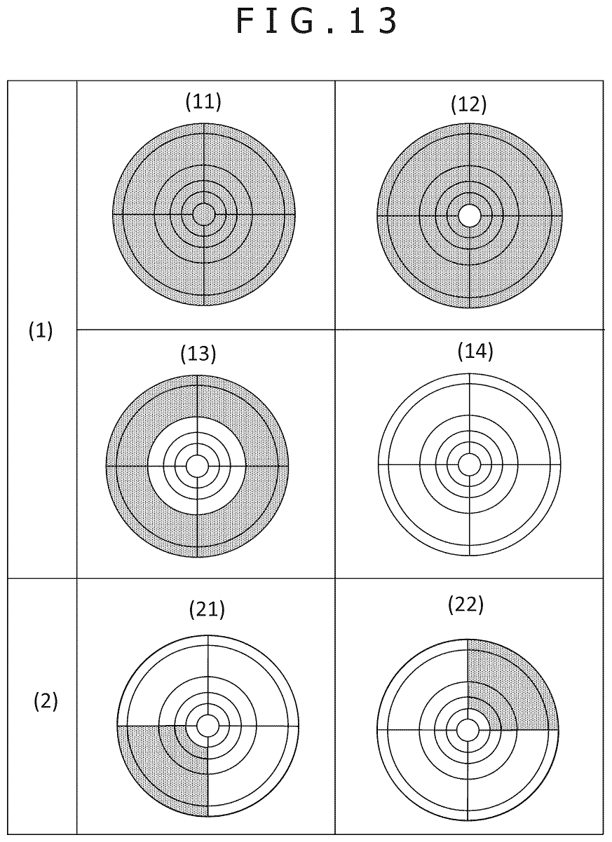

FIG. 13 is a diagram for explaining examples of patterns according to the diaphragm function of the incident light control area PCA and examples of the CAP pattern. In FIG. 13, (1) depicts examples of patterns for explaining the diaphragm function, and (2) depicts examples of the CAP pattern. In (1), (11) is a state in which the diaphragm is closed, (12) is a state in which the diaphragm is minimally narrowed, (13) is a state in which the diaphragm is slightly opened, and (14) is a state in which the diaphragm is maximally opened.

(11) can be displayed by setting all the areas of the first incident light control area TA1 and each area (VIil: i (positive integer)=2 to 6, l (positive integer)=1 to 4) of the respective divided areas (VI2 to VI6) to a non-transmission state.

(12) can be displayed by setting the first incident light control area TA1 to a transmission state and by setting all areas (VIil: i (positive integer)=2 to 6, l (positive integer)=1 to 4) of other divided areas (VI2 to VI6) to a non-transmission state.

(13) can be displayed by setting the areas from the first incident light control area TA1 to the fourth incident light control area TA4 to a transmission state and setting all areas (VIil: i (positive integer)=5 to 6, l (positive integer)=1 to 4) of other divided areas (VI5 to VI6) to a non-transmission state.

(14) can be displayed by setting all the areas of the first incident light control area TA1 and each area (VIil: i (positive integer)=2 to 6, l (positive integer)=1 to 4) of the respective divided regions (VI2 to VI6) to a transmission state.

(21) can be displayed by setting the areas from the first incident light control area TA1 to the second incident light control area TA2 to a transmission state, by setting all areas (VIil: i (positive integer)=3 to 6, l (positive integer)=1, 2, and 4) of the respective divided areas (VI3 to VI6) to a transmission state, and by setting all areas (VIil: i (positive integer)=3 to 6, l (positive integer)=3) of the respective divided areas (VI3 to VI6) to a non-transmission state.

(22) can be displayed by setting the areas from the first incident light control area TA1 to the second incident light control area TA2 to a transmission state, by setting all areas (VIil: i (positive integer)=3 to 6, l (positive integer)=2, 3, and 4) of the respective divided areas (VI3 to VI6) to a transmission state, and by setting all areas (VIil: i (positive integer)=3 to 6, l (positive integer)=1) of the respective divided areas (VI3 to VI6) to a non-transmission state.

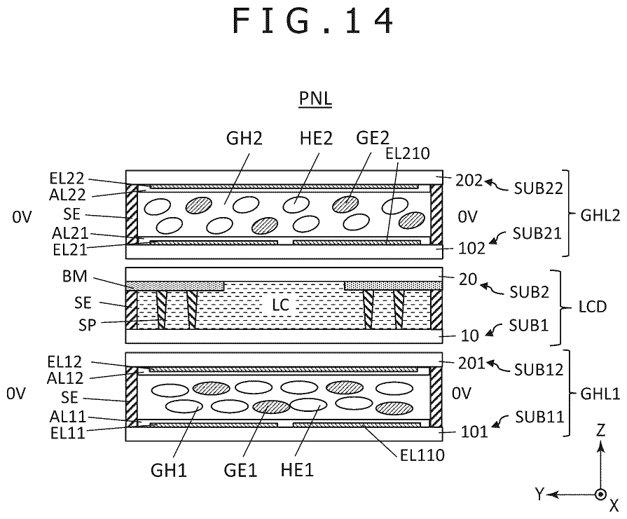

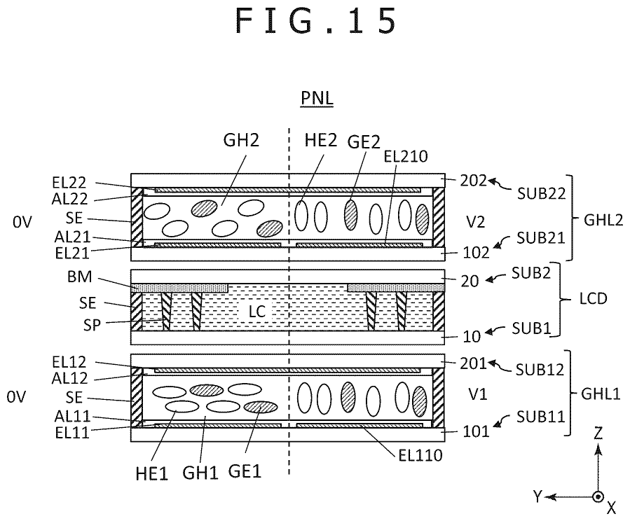

Next, a case where the first transparent electrode EL11 of the first guest-host liquid crystal cell GHL1 and the third transparent electrode EL21 of the second guest-host liquid crystal cell GHL2 are configured with divided segment electrodes will be described. FIG. 14 is a diagram for explaining a first state of a third configuration example of the liquid crystal panel according to the embodiment. FIG. 15 is a diagram for explaining a second state of the third configuration example of the liquid crystal panel according to the embodiment.

Liquid crystal panels PNL depicted in FIG. 14 and FIG. 15 are different from the liquid crystal panels PNL depicted in FIG. 5 and FIG. 6 in that the first transparent electrode EL11 of the first guest-host liquid crystal cell GHL1 is configured with divided segment electrodes (the first transparent electrode EL11 and a first transparent electrode EL110), and the third transparent electrode EL21 of the second guest-host liquid crystal cell GHL2 is configured with divided segment electrodes (the third transparent electrode EL21 and a third transparent electrode EL210).

In FIG. 14, the potentials between the two segment electrodes (first transparent electrodes EL11 and EL110) and the second transparent electrode EL12 of the first guest-host liquid crystal cell GHL1 are both 0 V, and the first guest-host liquid crystal cell GHL1 is in a black state. In addition, the potentials between the segment electrodes (third transparent electrodes EL21 and EL210) and the fourth transparent electrode EL22 of the second guest-host liquid crystal cell GHL2 are both 0 V, and the second guest-host liquid crystal cell GHL2 is in a black state. Thus, in the liquid crystal panel PNL depicted in FIG. 14, the entire surface of the first guest-host liquid crystal cell GHL1 and the entire surface of the second guest-host liquid crystal cell GHL2 function as polarizing plates.

On the other hand, in FIG. 15, the potential between one segment electrode (first transparent electrode EL11) and the second transparent electrode EL12 of the first guest-host liquid crystal cell GHL1 is 0 V, and the first guest-host liquid crystal cell GHL1 is in a black state. On the other hand, the potential between the other segment electrode (first transparent electrode EL110) and the second transparent electrode EL12 is a predetermined potential V1, and the first guest-host liquid crystal cell GHL1 is in a transparent state. In addition, the potential between one segment electrode (third transparent electrode EL21) and the fourth transparent electrode EL22 of the second guest-host liquid crystal cell GHL2 is 0 V, and the second guest-host liquid crystal cell GHL2 is in a black state. On the other hand, the potential between the other segment electrode (third transparent electrode EL210) and the fourth transparent electrode EL22 is a predetermined potential V2, and the second guest-host liquid crystal cell GHL2 is in a transparent state.

Thus, in FIG. 15, the areas (the area on the left side of the first guest-host liquid crystal cell GHL1 and the area on the left side of the second guest-host liquid crystal cell GHL2) on the left side of the liquid crystal panel PNL where the first transparent electrode EL11 and the third transparent electrode EL21 exist function as polarizing plates. On the other hand, the areas (the area on the right side of the first guest-host liquid crystal cell GHL1 and the area on the right side of the second guest-host liquid crystal cell GHL2) on the right side of the liquid crystal panel PNL where the first transparent electrode EL110 and the third transparent electrode EL210 exist are in a transparent state, and a high transmittance is obtained. That is, the area on the right side of the first guest-host liquid crystal cell GHL1 and the area on the right side of the second guest-host liquid crystal cell GHL2 are in a state in which they cannot be used as polarizing plates.

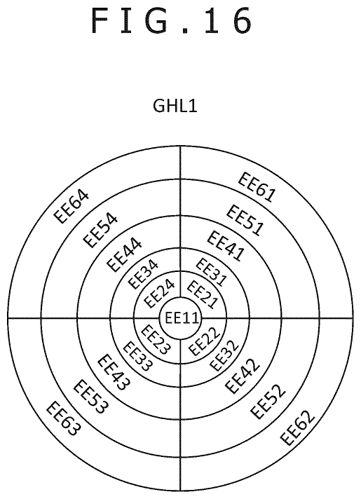

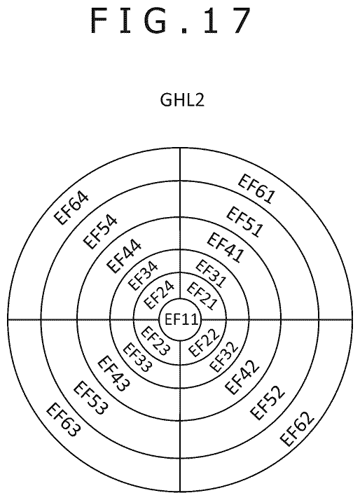

Next, the divided segment electrodes of the first transparent electrode (EL 11 in FIG. 5) and the third transparent electrode (EL 21 in FIG. 5) will be described by using FIG. 16 and FIG. 17. FIG. 16 is a diagram for explaining the divided segment electrodes of the first transparent electrode in the first guest-host liquid crystal cell. FIG. 17 is a diagram for explaining the divided segment electrodes of the third transparent electrode in the second guest-host liquid crystal cell.

As depicted in FIG. 16, in the first guest-host liquid crystal cell GHL1 of the liquid crystal panel PNL, the first transparent electrode EL11 is divided into a plurality of first segment electrodes EE (EE11, EE21 to EE24, EE31 to EE34, EE41 to EE44, EE51 to EE54, and EE61 to EE64). The plurality of first segment electrodes EE is divided so as to correspond to each of the first incident light control area TA1 and each area (VIil: i (positive integer)=2 to 6, l (positive integer)=1 to 4) of the respective divided areas (VI2 to VI6) described with reference to FIG. 10 and FIG. 11. The potential of each first segment electrode EE can be individually controlled by the control circuit DR2.

As depicted in FIG. 17, in the second guest-host liquid crystal cell GHL2 of the liquid crystal panel PNL, the third transparent electrode EL21 is divided into a plurality of second segment electrodes EF (EF11, EF21 to EF24, EF31 to EF34, EF41 to EF44, EF51 to EF54, and EF61 to EF64). The plurality of second segment electrodes EF is divided so as to correspond to each of the first incident light control area TA1 and each area (VIil: i (positive integer)=2 to 6, l (positive integer)=1 to 4) of the respective divided areas (VI2 to VI6) described with reference to FIG. 10 and FIG. 11. The potential of each second segment electrode EF can be individually controlled by the control circuit DR2.

For example, in the case of the diaphragm as depicted in (12) of FIG. 13, the control circuit DR2 controls as follows.

The control circuit DR2 controls the potentials between the pixel electrodes 11 and the common electrode 21 corresponding to the first incident light control area TA1 as depicted in FIG. 12 so that the first incident light control area TA1 is set to a transmission state. Then, the control circuit DR2 controls the potential between the first segment electrode EE11 of the first transparent electrode EL11 and the second transparent electrode EL12 corresponding to the first incident light control area TA1 and the potential between the second segment electrode EF11 of the third transparent electrode EL21 and the fourth transparent electrode EL22 to control to set to a transparent state.

In addition, the control circuit DR2 controls the potentials between the pixel electrodes 11 and the common electrodes 21 corresponding to the second incident light control area TA2 to the sixth incident light control area TA6 so that the second incident light control area TA2 to the sixth incident light control area TA6 are set to a non-transmission state. Further, the control circuit DR2 controls the potentials between the first segment electrodes (EE21 to EE24, EE31 to EE34, EE41 to EE44, EE51 to EE54, and EE61 to EE64) of the first transparent electrodes EL11 and the second transparent electrodes EL12 corresponding to the second incident light control area TA2 to the sixth incident light control area TA6 and the potentials between the second segment electrodes (EF21 to EF24, EF31 to EF34, EF41 to EF44, EF51 to EF54, and EF61 to EF64) of the third transparent electrodes EL21 and the fourth transparent electrodes EL22 to control to set to a black state.

With the concept similar to the above for the other patterns (11), (13), (14), (21), and (22) in FIG. 13, the control circuit DR2 can display the pattern according to the diaphragm function or the CAP pattern on the incident light control area PCA by controlling the first incident light control area TA1 and each area (VIil: i (positive integer)=2 to 6, l (positive integer)=1 to 4) of the respective divided areas (VI2 to VI6), controlling the plurality of first segment electrodes EE of the first guest-host liquid crystal cell GHL1, and controlling the plurality of second segment electrodes EF of the second guest-host liquid crystal cell GHL2.

In other words, the shapes of the plurality of first segment electrodes EE and the shapes of the plurality of second segment electrodes EF correspond to the shapes of the plurality of incident light control areas (the first incident light control area TA1 and each area (VIil: i (positive integer)=2 to 6, l (positive integer)=1 to 4) of the respective divided areas (VI2 to VI6)). Then, when one or more of the plurality of incident light control areas are set to a non-transmission state under the control of the control circuit DR2 and when areas other than the one or more of the plurality of incident light control areas are set to a transmission state, the control circuit DR2 controls one or more of the plurality of first segment electrodes EE and one or more of the plurality of second segment electrodes EF corresponding to the one or more of the plurality of incident light control areas to set them to a black state, and sets electrodes other than the one or more of the plurality of first segment electrodes EE and other than the one or more of the plurality of second segment electrodes EF to a transparent state.

According to this configuration, by dividing the first transparent electrodes (EL11 and EL110) and the third transparent electrodes (EL21 and EL210) of the guest-host liquid crystal cells (GHL1 and GHL2) into the first segment electrodes EE (see FIG. 16) and the second segment electrodes EF (see FIG. 17), the areas (areas in a black state) to function as polarizing plates can be divided in the plane of the liquid crystal panel PNL. The driving areas of the guest-host liquid crystal cells (GHL1 and GHL2) are controlled by the control circuit DR2 in accordance with the driving of the liquid crystal device LCD. Accordingly, a place to be shielded from light can be shielded from light, and a place to be transmitted can be further transmitted, so that both a high contrast ratio and a high transmittance can be achieved.

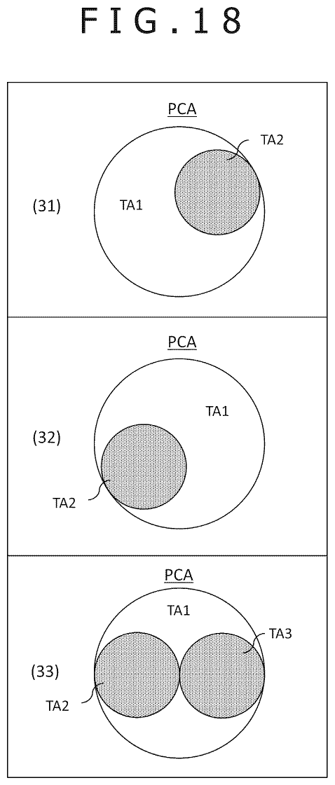

The shapes of the segment electrodes are not limited to FIG. 16 and FIG. 17. The shapes of the segment electrodes may be, for example, shapes as depicted in FIG. 18. FIG. 18 is a diagram for depicting another configuration example of the incident light control area PCA. FIG. 18 depicts configuration examples of the CAP pattern. In FIG. 18, (31) is a configuration in which the incident light control area PCA includes a large circular-shaped first incident light control area TA1 and a small circular-shaped second incident light control area TA2 provided on the upper right side of the first incident light control area TA1.

(32) is a configuration in which the incident light control area PCA includes a large circular-shaped first incident light control area TA1 and a small circular-shaped second incident light control area TA2 provided on the lower left side of the first incident light control area TA1.

(33) is a configuration in which the incident light control area PCA includes a large circular-shaped first incident light control area TA1, and a circular-shaped second incident light control area TA2 and a circular-shaped third incident light control area TA3 arranged side by side in a horizontal direction inside the first incident light control area TA1.

As similar to the description with reference to FIG. 10, FIG. 11, FIG. 16, and FIG. 17, the configurations and shapes of the incident light control areas of the incident light control area PCA, the configurations and shapes of the segment electrodes of the first transparent electrode EL11 of the first guest-host liquid crystal cell GHL1, and the configurations and shapes of the segment electrodes of the third transparent electrode EL21 of the second guest-host liquid crystal cell GHL2 may be configured so as to match (31), (32), and (33) in FIG. 18. The configuration of the incident light control area PCA may be other than the configuration depicted in FIG. 18.

All of camera modules that can be implemented by a person skilled in the art with appropriate design changes on the basis of the camera module described above as the embodiment of the present disclosure are also within the scope of the present disclosure as long as the gist of the present disclosure is included.

In the category of the idea of the present disclosure, it is understood that a person skilled in the art can arrive at various change examples and modification examples, and the change examples and modification examples also belong to the scope of the present disclosure. For example, modes obtained by appropriately adding or deleting a constitutional element to/from each embodiment described above, or changing the design thereof, or by adding or omitting a process to/from each embodiment described above, or changing the conditions thereof by a person skilled in the art are included in the scope of the present disclosure as long as the gist of the present disclosure is provided.

In addition, it is understood that other working effects obtained by the mode described in the present embodiment that are apparent from the description of the specification or that a person skilled in the art can appropriately arrive at are naturally obtained by the present disclosure.

Various disclosures can be formed by appropriate combinations of a plurality of constitutional elements disclosed in the above embodiment. For example, some constitutional elements may be deleted from all the constitutional elements depicted in the embodiment. Further, constitutional elements across different embodiments may be appropriately combined with each other.

What is claimed is:

1. A camera module comprising:
a liquid crystal panel that has an incident light control area;
a lens;
an imaging device that acquires information of light transmitted through the incident light control area of the liquid crystal panel and the lens; and
a control circuit, wherein
the liquid crystal panel includes
a first guest-host liquid crystal cell that has a black state and a transparent state,
a second guest-host liquid crystal cell that has a black state and a transparent state, and
a liquid crystal device that is provided between the first guest-host liquid crystal cell and the second guest-host liquid crystal cell and has the incident light control area, and
the control circuit sets the first guest-host liquid crystal cell and the second guest-host liquid crystal cell to the black state to use the first guest-host liquid crystal cell and the second guest-host liquid crystal cell as polarizing plates.

2. The camera module according to claim 1, wherein
the first guest-host liquid crystal cell includes a first guest-host liquid crystal layer including a first dichroic dye and a first liquid crystal molecule, a first transparent electrode, and a second transparent electrode, and a potential between the first transparent electrode and the second transparent electrode is controlled by the control circuit to control the black state and the transparent state of the first guest-host liquid crystal cell, and
the second guest-host liquid crystal cell includes a second guest-host liquid crystal layer including a second dichroic dye and a second liquid crystal molecule, a third transparent electrode, and a fourth transparent electrode, and a potential between the third transparent electrode and the fourth transparent electrode is controlled by the control circuit to control the black state and the transparent state of the second guest-host liquid crystal cell.

3. The camera module according to claim 2, wherein
the incident light control area includes a plurality of incident light control areas,
each of the plurality of incident light control areas has a wiring pair connected to the control circuit such that a transmission state for allowing external light to transmit and a non-transmission state for blocking the external light can be set under the control of the control circuit, and
a diaphragm function or a coded aperture pair pattern is configured in the incident light control area under the control of the control circuit.

4. The camera module according to claim 3, wherein
the first transparent electrode has a plurality of first segment electrodes,
the third transparent electrode has a plurality of second segment electrodes,
shapes of the plurality of first segment electrodes and shapes of the plurality of second segment electrodes correspond to shapes of the plurality of incident light control areas, and
when one or more of the plurality of incident light control areas are set to the non-transmission state under the control of the control circuit and when areas other than the one or more of the plurality of incident light control areas are set to the transmission state, the control circuit controls one or more of the plurality of first segment electrodes and one or more of the plurality of second segment electrodes corresponding to the one or more of the plurality of incident light control areas to set them to the black state, and sets electrodes other than the one or more of the plurality of first segment electrodes and other than the one or more of the plurality of second segment electrodes to the transparent state.
